(19) United States
(12) Patent Application Publication
(10) Pub. No.: US 2025/0208802 A1
(43) Pub. Date: Jun. 26, 2025

(54) SERVER APPARATUS, CONTROL METHOD OF SAME, STORAGE MEDIUM, AND MANAGEMENT SYSTEM

(71) Applicant: CANON KABUSHIKI KAISHA, Tokyo (JP)

(72) Inventor: MAREHIKO HIRAJIMA, Kanagawa (JP)

(21) Appl. No.: 19/079,570

(22) Filed: Mar. 14, 2025

Related U.S. Application Data
(63) Continuation of application No. PCT/JP2023/029417, filed on Aug. 14, 2023.

(30) Foreign Application Priority Data
Sep. 22, 2022 (JP) 2022-151800

(51) Int. Cl. G06F 3/12

(52) U.S. Cl. CPC G06F 3/1239; G06F 3/1203; G06F 3/1238

(57) ABSTRACT

A server apparatus manages a contract related to use of an image forming apparatus, the contract specifying a number of printable pages in a predetermined period for the image forming apparatus. The server apparatus accepts a change request for increasing the number of printable pages in a first contract managed. The server apparatus changes the number of printable pages in the first contract by performing change processing for decreasing the number of printable pages in a second contract by a requested number of pages indicated in the change request, and increasing the number of printable pages in the first contract by the requested number of pages indicated in the change request.

### CROSS-REFERENCE TO RELATED APPLICATION(S)

This application is a Continuation of International Patent Application No. PCT/JP2023/029417, filed Aug. 14, 2023, which claims the benefit of Japanese Patent Application No. 2022-151800 filed Sep. 22, 2022, both of which are hereby incorporated by reference herein in their entirety.

### BACKGROUND OF THE INVENTION

### Field of the Invention

The present invention relates to a server apparatus for managing an image forming apparatus, a control method of the same, a storage medium, and a management system.

### Description of the Related Art

Japanese Patent Laid-Open No. 2021-110775 describes an image forming apparatus that can operate in a contract mode in which printing performed by the image forming apparatus is managed by a server. The server provides a subscription service in which, while the number of pages printed by the image forming apparatus operating in the contract mode is below an upper limit number of pages in a fixed period (one month) specified in the contract, a fixed amount is charged regardless of the number of pages printed.

In a subscription service such as that described above, the upper limit of the number of pages that can be printed each month by the managed image forming apparatus is specified in the contract. However, depending on the month, it may be necessary to print more sheets than the upper limit specified in the contract, or there may be a surplus in the number of printable sheets relative to the upper limit specified in the contract. In such cases, there is a demand for the ability to more flexibly change the number of printable pages specified in the contract for providing the subscription service, even during the month.

### SUMMARY OF THE INVENTION

In view of this, the present disclosure provides a technique that makes it possible to more flexibly change of the number of printable pages (sheets) specified in a contract regarding the use of an image forming apparatus managed by a server apparatus.

According to one aspect of the present disclosure, there is provided a server apparatus that manages an image forming apparatus, the server apparatus comprising: a management unit configured to manage a contract related to use of the image forming apparatus, the contract specifying a number of printable pages in a predetermined period for the image forming apparatus; an acceptance unit configured to accept a change request for increasing the number of printable pages in a first contract managed by the management unit; and a processing unit configured to change the number of printable pages in the first contract by performing change processing for decreasing the number of printable pages in a second contract, which is managed by the management unit and different from the first contract, by a requested number of pages indicated in the change request accepted by the acceptance unit, and increasing the number of printable pages in the first contract by the requested number of pages indicated in the change request, wherein the number of printable pages in the predetermined period for the image forming apparatus is a sum of the number of printable pages specified in each contract managed by the management unit and a carry-over number of pages carried over from a previous predetermined period due to a surplus in the number of printable pages specified in the contract in the previous predetermined period.

Other features and advantages of the present invention will be apparent from the following description taken in conjunction with the accompanying drawings. Note that the same reference numerals denote the same or like components throughout the accompanying drawings.

### BRIEF DESCRIPTION OF THE DRAWINGS

The accompanying drawings, which are incorporated in and constitute a part of the specification, illustrate embodiments of the invention and, together with the description, serve to explain principles of the invention.

FIGS. 1A and 1B are perspective views showing an example of the appearance of an image forming apparatus;

FIG. 2 is a cross-sectional view showing an example of the internal physical configuration of the image forming apparatus;

FIG. 3 is a schematic diagram showing an example of the configuration of a management system;

FIG. 4 is a block diagram showing an example of the configuration of a management server;

FIG. 5 is a diagram showing an example of a display screen of a user terminal;

FIG. 6 is a sequence diagram showing an example of request destination user ID registration processing;

FIGS. 7A to 7E are diagrams showing examples of display screens related to the request destination user ID registration processing;

FIG. 8 is a sequence diagram showing an example of change processing for changing the number of printable pages;

FIGS. 9A to 9F are diagrams showing examples of display screens related to the change processing;

FIG. 10 is a diagram showing an example of a display screen of a user terminal (second embodiment); and

FIGS. 11A to 11F are diagrams showing examples of display screens of a user terminal (third embodiment).

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

First, an image forming apparatus to be managed in a management system according to the first embodiment of the present disclosure will be described. The present embodiment is applicable to image forming apparatuses such as copiers, printers, facsimile receivers, and multifunction machines. The image forming apparatus of the present embodiment is a monochrome laser printer, but may be another type of printer, such as a color laser printer or an inkjet printer.

### Image Forming Apparatus

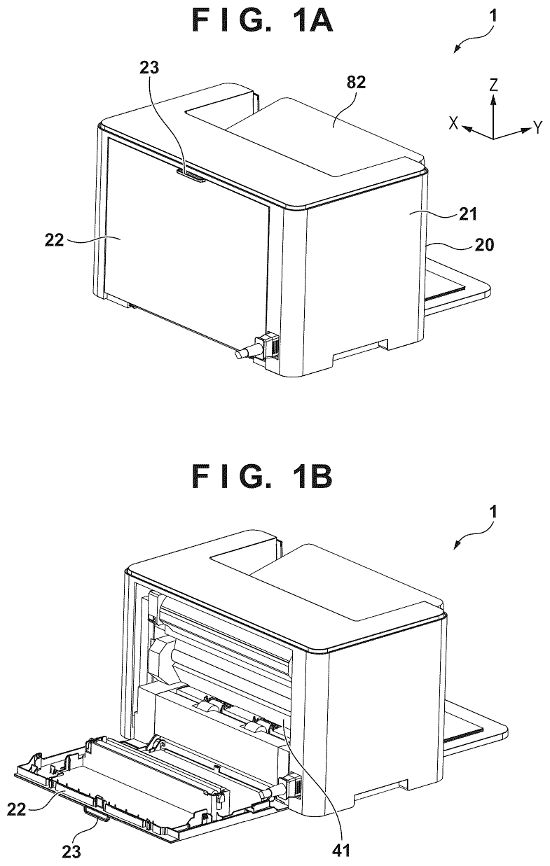

FIGS. 1A and 1B are perspective views showing an example of the appearance of an image forming apparatus 1 according to the present embodiment. The image forming apparatus 1 is a monochrome laser printer that forms an image on a recording medium based on input image data. Note that the recording medium can be any of a variety of media made of different materials, such as paper, plastic film, an envelope, a sheet, and cloth. In the following description, the Z direction is the height direction of the image forming apparatus 1 when the image forming apparatus 1 is placed on a horizontal surface. The X direction is a direction orthogonal to the Z direction and parallel to the rotation axis direction (main scanning direction) of a photosensitive drum 44 described later. The Y direction is a direction orthogonal to the X direction and the Z direction.

As shown in FIGS. 1A and 1B, the housing of the image forming apparatus 1 includes a front cover 20, an exterior cover 21, a rear cover 22, and a discharge tray 82. The rear cover 22 is provided with a handle 23. The front cover 20 is provided on one side of the image forming apparatus 1 so as to be openable and closable, and protects a processing circuit 90, which will be described later. The rear cover 22 is provided on the other side of the image forming apparatus 1 so as to be openable and closable. FIG. 1A shows a state in which the rear cover 22 is closed, and FIG. 1B shows a state in which the rear cover 22 is open.

A user can grasp the handle 23 of the rear cover 22 and open the rear cover 22 to expose a process unit 41 and a portion of the conveying path along which the recording medium is conveyed. While the rear cover 22 is open, the user can perform maintenance work such as resolving a jam or replacing the process unit 41.

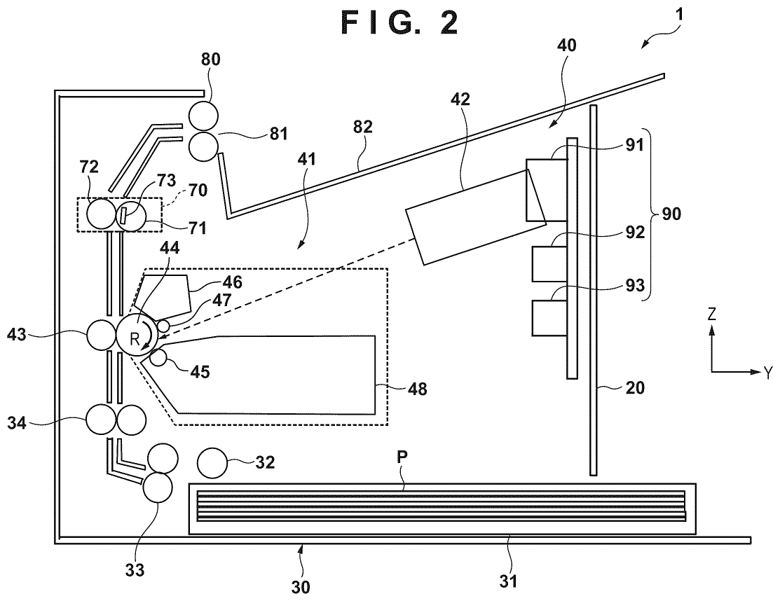

FIG. 2 is a cross-sectional view showing an example of the internal physical configuration of the image forming apparatus 1. The image forming apparatus 1 includes a feeding unit 30, an image forming unit 40, a fixing unit 70, a pair of discharge rollers 80, and the processing circuit 90. The feeding unit 30 feeds a recording medium P to a conveying path and conveys the recording medium P toward the image forming unit 40. The image forming unit 40 forms an image (toner image) on the recording medium P using toner, which is a consumable material. The fixing unit 70 fixes the image formed by the image forming unit 40 onto the recording medium P. The pair of discharge rollers 80 discharge the recording medium P processed by the fixing unit 70 onto the discharge tray 82.

The image forming unit 40 includes the process unit 41, a scanner unit 42, and a transfer roller 43. The process unit 41 includes the photosensitive drum 44, a developing roller 45, a cleaning unit 46, a charging roller 47, and a reservoir 48. The process unit 41 may be fixed to the body of the image forming apparatus 1 or may be detachable from the body of the image forming apparatus 1.

The photosensitive drum 44 is an image carrier, and has a photosensitive layer formed from an organic photosensitive material on a drum-shaped substrate. The photosensitive drum 44 is rotated in the R direction shown in FIG. 2 by a motor. A charging voltage is applied to the charging roller 47 by a high voltage power supply while the charging roller 47 is pressed against the photosensitive drum 44, thereby uniformly charging the surface of the photosensitive drum 44. The scanner unit 42 irradiates the photosensitive drum 44 with laser light in accordance with input image data to expose the surface of the photosensitive drum 44. This exposure forms an electrostatic latent image corresponding to the input image on the surface of the photosensitive drum 44. Note that the scanner unit 42 may be configured to irradiate the photosensitive drum 44 with light from an LED array instead of laser light.

The developing roller 45 is rotatably supported by the reservoir 48. The reservoir 48 stores toner. Although not shown in FIG. 2, the reservoir 48 may further include a supply roller that applies the toner stored in the reservoir 48 onto the surface of the developing roller 45. A developing voltage is applied to the developing roller 45 by a high voltage power supply. When the toner carried by the developing roller 45 comes into contact with the photosensitive drum 44, the toner moves from the developing roller 45 to the surface of the photosensitive drum 44 in accordance with the potential distribution on the surface of the photosensitive drum 44. A toner image is thus developed from the electrostatic latent image.

The feeding unit 30 includes a cassette 31, a pickup roller 32, a pair of separation rollers 33, and a pair of conveying rollers 34. A stack of recording media P is loaded in the cassette 31. The cassette 31 can be pulled out from the housing of the image forming apparatus 1. The pickup roller 32 picks up a recording medium P from the cassette 31 and sends the recording medium P toward the pair of separation rollers 33. The pair of separation rollers 33 separate one recording medium P and conveys it toward the pair of conveying rollers 34. The pair of conveying rollers 34 conveys the recording medium P toward the transfer nip between the transfer roller 43 and the photosensitive drum 44. A transfer voltage is applied to the transfer roller 43 by a high voltage power supply, and the transfer roller 43 transfers the toner image from the surface of the photosensitive drum 44 to the recording medium P conveyed to the transfer nip.

The recording medium P onto which the toner image has been transferred is conveyed along a conveying path and reaches the fixing unit 70. The fixing unit 70 includes a heating roller 71, a pressing roller 72, and a fixing heater 73. The heating roller 71 and the pressing roller 72 apply heat and pressure to the recording medium P as the recording medium P passes through the nip between these rollers. As a result, the toner particles constituting the toner image on the recording medium P are melted and then fixed, thus fixing the toner image to the recording medium P.

The recording medium P that has passed through the fixing unit 70 is discharged by the pair of discharge rollers 80 through a discharge opening 81 onto the discharge tray 82. The cleaning unit 46 is disposed in the vicinity of the photosensitive drum 44. The cleaning unit 46 cleans the photosensitive drum 44 by scraping off the toner remaining on the surface of the photosensitive drum 44.

The processing circuit 90 includes a group of electronic components 91, 92, and 93 arranged on a substrate. For example, the electronic component 91 may be a processor, the electronic component 92 may be a memory, and the electronic component 93 may be an input/output device. The input/output device may include a communication interface. When a job instructing image formation is input to the image forming apparatus 1, an image forming process that is based on input image data received from, for example, an external computer is started.

In the image forming process, as described above, the scanner unit 42 forms an electrostatic latent image on the photosensitive drum 44 according to the input image data. The developing roller 45 develops the electrostatic latent image formed on the photosensitive drum 44 with toner, thereby forming a toner image on the photosensitive drum 44. The transfer roller 43 transfers the toner image from the photosensitive drum 44 onto the recording medium P at the transfer nip. The processing circuit 90 operates as a controller for controlling the image forming process.

### Management System

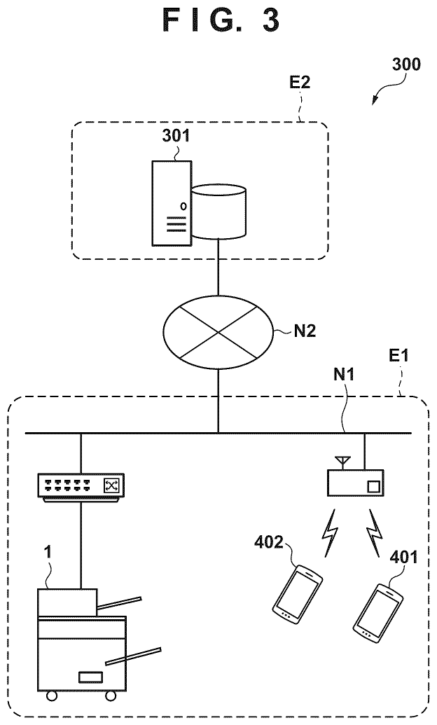

FIG. 3 is a schematic diagram showing an example of the configuration of a management system 300 according to the present embodiment. The management system 300 includes the image forming apparatus 1, a management server 301, and user terminals 401 and 402.

The image forming apparatus 1 is disposed in a user environment E1 in which users are located. The user terminal 401 is also located in the user environment E1 and is used by a user. The image forming apparatus 1 and the user terminals 401 and 402 are connected to a local network N1. The local network N1 can be, for example, a local area network (LAN). In the user environment E1, users use the image forming apparatus 1. As described above, the image forming apparatus 1 forms images on recording media using toner.

The management server 301 is disposed in a remote environment (remote environment E2) that is distant from the environment in which the image forming apparatus 1 is disposed (user environment E1). The remote environment E2 is connected to the local network N1 via an external network N2. The external network N2 can be, for example, the Internet or a virtual private network (VPN). The local network N1 and the external network N2 can each include any types of network devices, such as routers, switches, gateways, wireless access points, and base stations. Additionally, the local network N1 and the external network N2 can each include any number of network devices.

In the present embodiment, the management server 301 is a server apparatus that manages the image forming apparatus 1. The management server 301 remotely manages how the image forming apparatus 1 is used by respective users, for example. The management server 301 also manages the number of printed pages (sheets) printed by the image forming apparatus 1 and user account information, and centrally manages the usage status of the image forming apparatus 1 for each of a plurality of users. The management server 301 may be implemented as an application server, a database server, or a cloud server, using a general-purpose computer, for example.

The user terminals 401 and 402 are terminal devices that provide users with a user interface for supporting the management functions of the management server 301. The user terminals 401 and 402 can be general-purpose terminal devices such as a smartphone, a mobile phone, a PC (Personal Computer), or a PDA (Personal Digital Assistant). The image forming apparatus 1 may also provide a user interface to the user.

Note that the functions of the management server 301 may be provided by a single device, or may be provided by a plurality of physically separate devices working in conjunction with each other. Furthermore, some of the databases described as being held by the management server 301 may be held by a device separate from the management server 301 (e.g., another database server).

### Configuration of Management Server

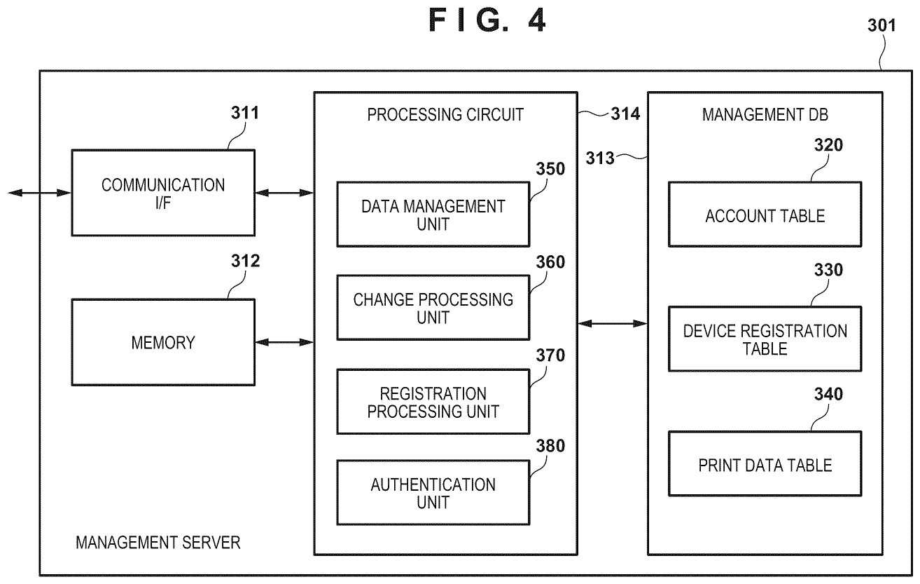

FIG. 4 is a block diagram showing an example of the configuration of the management server 301 according to the present embodiment. The management server 301 includes a communication interface (I/F) 311, a memory 312, a management database (DB) 313, and a processing circuit 314.

The communication I/F 311 is an interface for the management server 301 to communicate with other devices. For example, the communication I/F 311 communicates with the image forming apparatus 1 and the user terminals 401 and 402 that are located in the user environment E1. The communication I/F 311 may be a wired communication interface or a wireless communication interface.

The memory 312 may include any type of storage medium, such as a semiconductor memory (e.g., a Read Only Memory (ROM) or a Random Access Memory (RAM)), an optical disk, or a magnetic disk. The memory 312 may include a non-transitory computer-readable storage medium. The memory 312 stores one or more computer programs executed by the processing circuit 314, and various types of data, such as data used by the processing circuit 314.

The management DB 313 includes a group of tables for managing contracts regarding the use of one or more image forming apparatuses under the management of the management system 300 (management server 301). Specifically, as shown in FIG. 4, the management DB 313 includes an account table 320, a device registration table 330, and a print data table 340. In the present embodiment, a business operator who operates the management system 300 uses the management server 301 to provide a subscription service regarding the use of managed image forming apparatuses. In this subscription service, while the number of printed pages printed by the image forming apparatus is below the upper limit number of pages specified in the contract in a predetermined period (e.g., one month), a fixed amount is charged regardless of the number of printed pages. The user enters into a contract with the business operator to receive the subscription service. The following information included in the tables in the management DB 313 is associated with the contract that the user has made with the business operator.

The account table 320 is a table that holds information regarding user accounts. The account table 320 can include, for example, one or more of the items shown below:
“User ID”
“Password”
“Name”
“Email address”
“Address”
“Contract type (plan)”
“Payment method”
“Request destination user ID”
“Serial number (Serial No.)”

The “user ID” item is identification information for uniquely identifying the user account. The “password” item is used in user authentication when the user logs into the system. Also, the “name” item indicates the user name of the account. The user name is displayed on the screen after login, for example. The “email address” item can be used when the system sends various notifications to the user via email. Also, the “contract type (plan)” item indicates the type of contract (plan) that the user has entered into with the business operator that operates the management system 300. For each contract type (plan), the number of printable pages that can be printed by the image forming apparatus 1 in the predetermined period is determined in advance. The “payment method” item is information regarding the method of paying for the subscription service for using the image forming apparatus 1 for the contract plan.

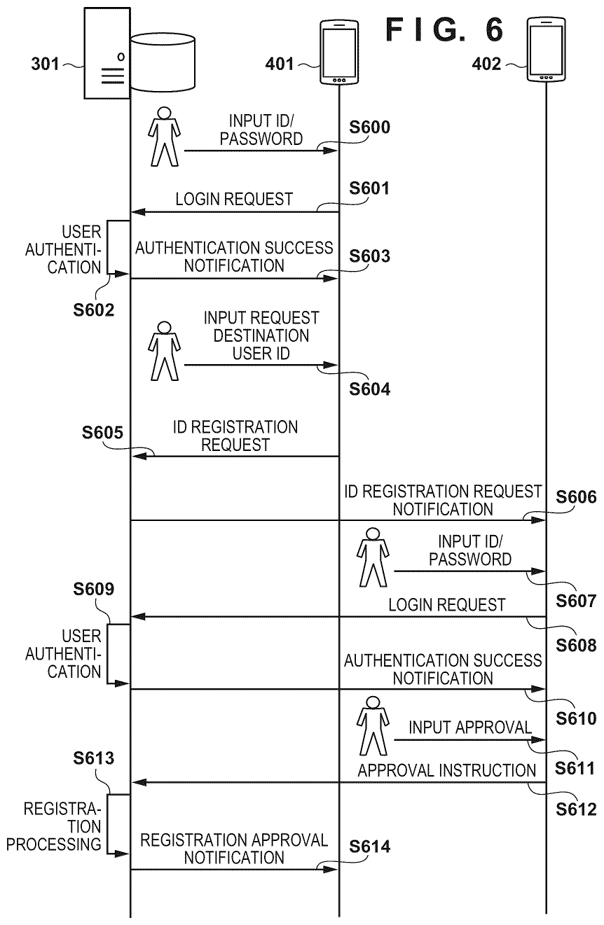

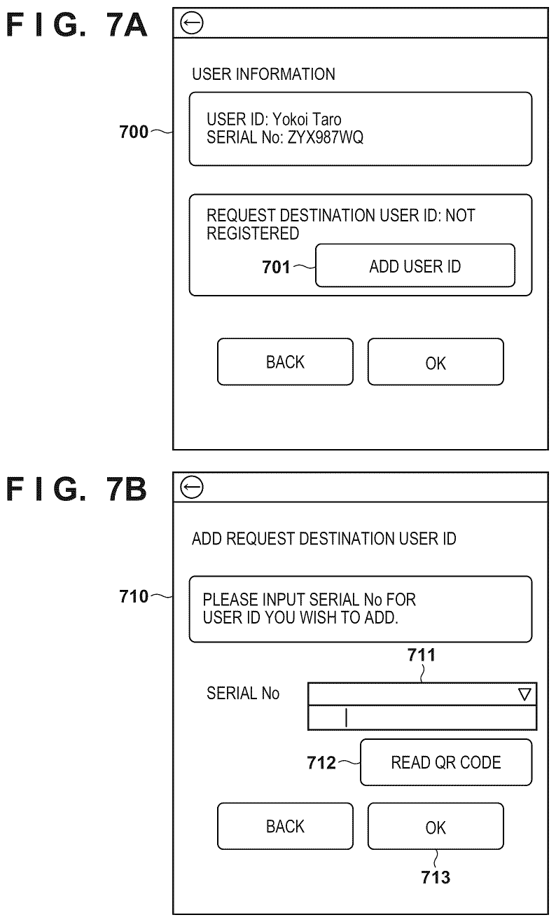

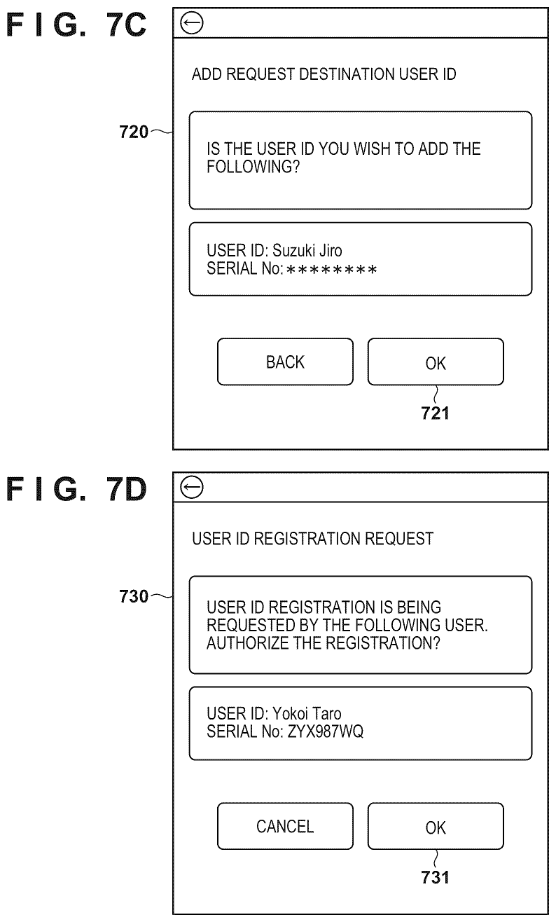

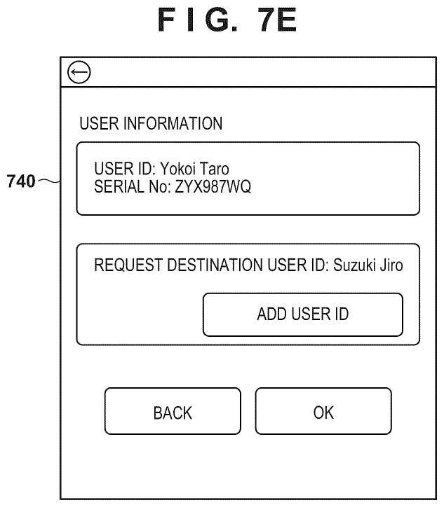

The “request destination user ID” item is the user ID to which a request is made when a contract user who has entered into a contract with the business operator requests an increase in the number of printable pages specified in the contract, as will be described later with reference to FIG. 6 and FIGS. 7A to 7E. The serial number is identification information that can be used as a search key to identify a user ID.

The device registration table 330 is a table for holding information regarding the image forming apparatuses registered in the management system 300 as devices corresponding to users. The device registration table 330 can include, for example, one or more of the items shown below:
“Owner”
“Device ID”
“Registration date”
“Status”

Here, the “owner” item indicates the account of the user who owns or manages the image forming apparatus, using a “user ID” registered in the account table 320. The “device ID” item is identification information for uniquely identifying the image forming apparatus. A pair of “owner” and “device ID” indicates the association between a user account and at least one image forming apparatus registered as a device of the user corresponding to the user account. One user account may be associated with two or more image forming apparatuses. The “registration date” item indicates the date on which the “device ID” of the image forming apparatus was registered in the device registration table 330. Also, the “status” item indicates a status of verification of whether the image forming apparatus is actually disposed in the user environment of the “owner”. At the time of initial registration of the “device ID”, the “status” may indicate “not verified”, and once verification is complete, the “status” may be changed to “verified”.

The print data table 340 is a table that holds data regarding printing. The print data table 340 can include, for example, one or more of the items shown below:
“Current month contract pages”
“Carried over pages”
“Current month available pages”
“Used pages”
“Available pages”

The “current month contract pages” item is determined for each contract plan described above, and is the number of pages that can be printed each month (each predetermined period) as determined in the contract with the business operator that operates the management system 300. The “carried over pages” item is the number of printable pages that has been carried over from the previous month (from the previous predetermined period) due to a surplus in the number of printable pages each month as specified in the contract. The “current month available pages” item is the sum of “current month contract pages” and “carried over pages”. The “used pages” item is the number of pages that have been printed in the current month. The “available pages” item indicates the remaining number of pages that can be printed in the current month. The data in the print data table 340 is associated with the information regarding user accounts in the account table 320.

The processing circuit 314 can be, for example, a central processing unit (CPU). The processing circuit 314 executes computer programs stored in the memory 312 to provide the functions of the management server 301. More specifically, as shown in FIG. 4, the processing circuit 314 can function as a change processing unit 360, a registration processing unit 370, and an authentication unit 380.

A data management unit 350 manages the registration and updating of data in the management DB 313. In the present embodiment, the data management unit 350 also manages contracts regarding the use of the image forming apparatus 1, which specify the number of printable pages that can be printed by the image forming apparatus 1 within a predetermined period (e.g., one month).

The data management unit 350 may cause the user terminal 401 to display a screen for accepting input of account information to be registered in the account table 320. In this case, the data management unit 350 may receive the input account information from the user terminal 401 via the communication I/F 311 and register the received account information in the account table 320. Furthermore, the data management unit 350 may cause the user terminal 401 to display a screen for receiving input of device information regarding the image forming apparatuses owned by users. In this case, the data management unit 350 may receive the input device information from the user terminal 401 via the communication I/F 311 and register the received device information in the device registration table 330.

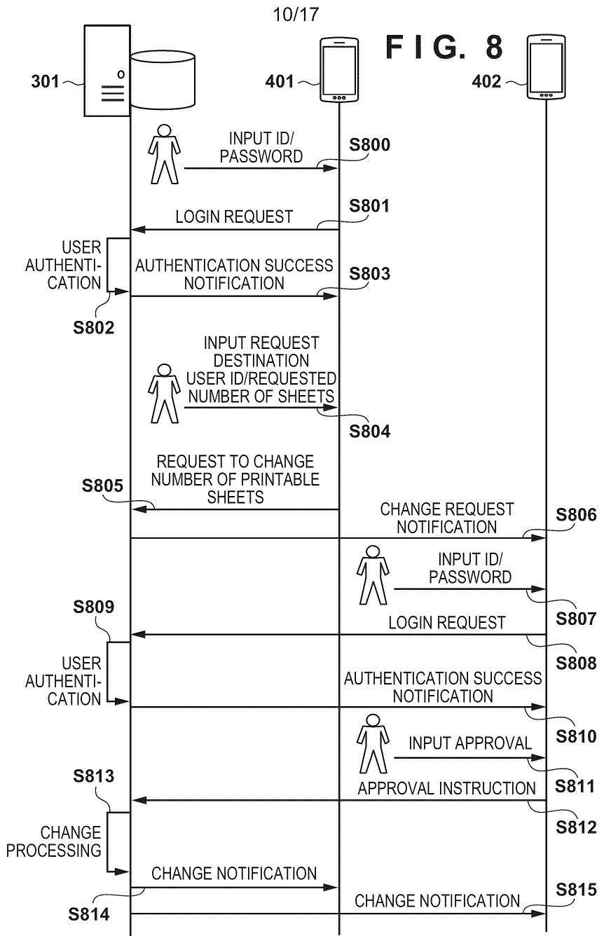

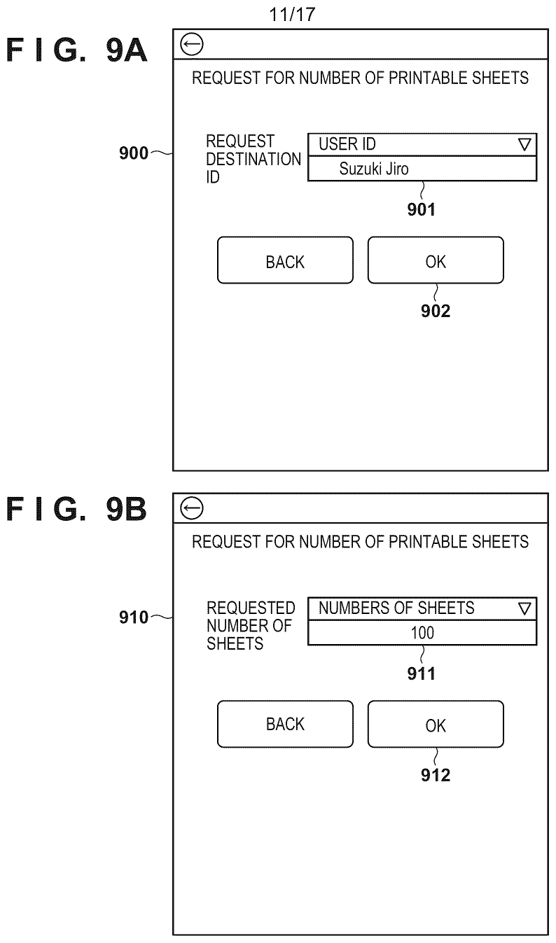

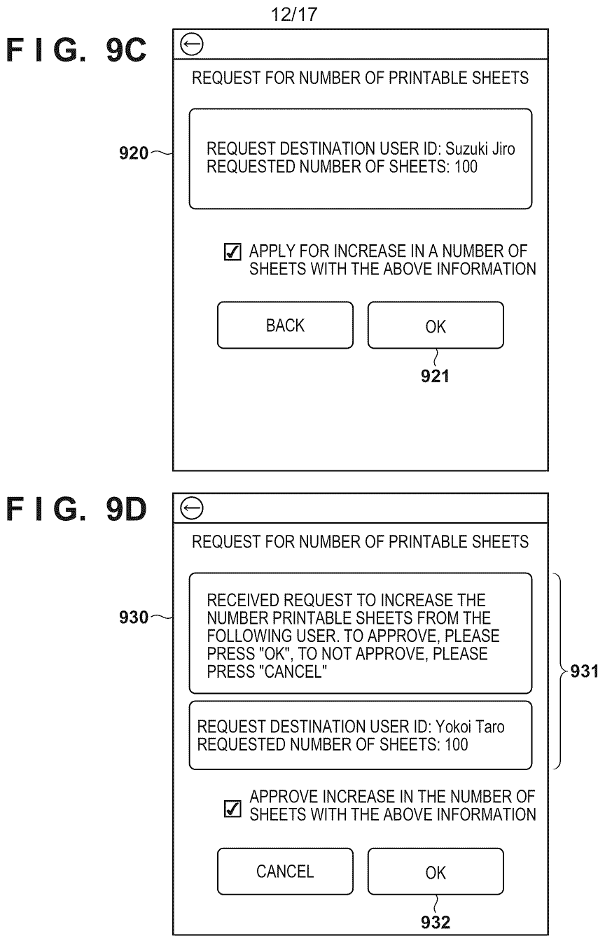

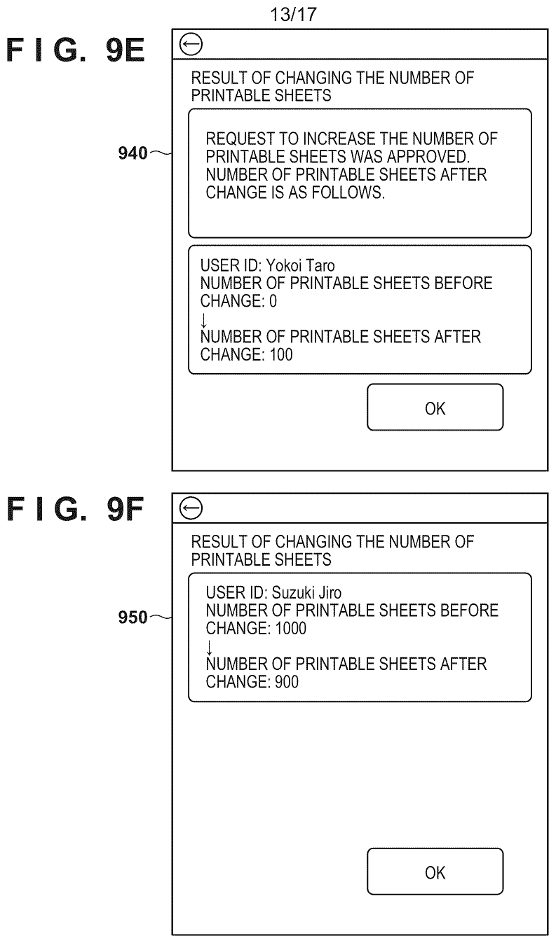

The change processing unit 360 performs change processing for, in response to a change request from a contract user who has made a contract with the business operator, changing the number of printable pages in the contract. The change processing will be described in detail later with reference to FIG. 8 and FIGS. 9A to 9F. The registration processing unit 370 performs registration processing for registering, in association with a contract that a contract user has made with the business operator, one or more user IDs that can be used as a request destination user ID for requesting an increase in the number of printable pages in the contract. The registration processing will be described in detail later with reference to FIG. 6 and FIGS. 7A to 7E.

The authentication unit 380 performs login authentication for a user to log in to the management system 300. For example, the authentication unit 380 causes the user terminal 401 to display a login screen for accepting input of a user ID and a password, and receives the input user ID and password from the user terminal 401 via the communication I/F 311. The authentication unit 380 further performs user authentication using the received user ID and password and a user ID and password stored in the account table 320.

The input screens displayed on the user terminal 401 by the data management unit 350, the change processing unit 360, the registration processing unit 370, and the authentication unit (image forming apparatus 1) can be provided in any format, such as a web page, an input form, or an application screen. For example, the input of device information to the user terminal 401 may be accepted while the user is logged in to the management system 300 (management server 301) after user authentication using the user ID and password stored in the account table 320 is successful.

### GUI Example

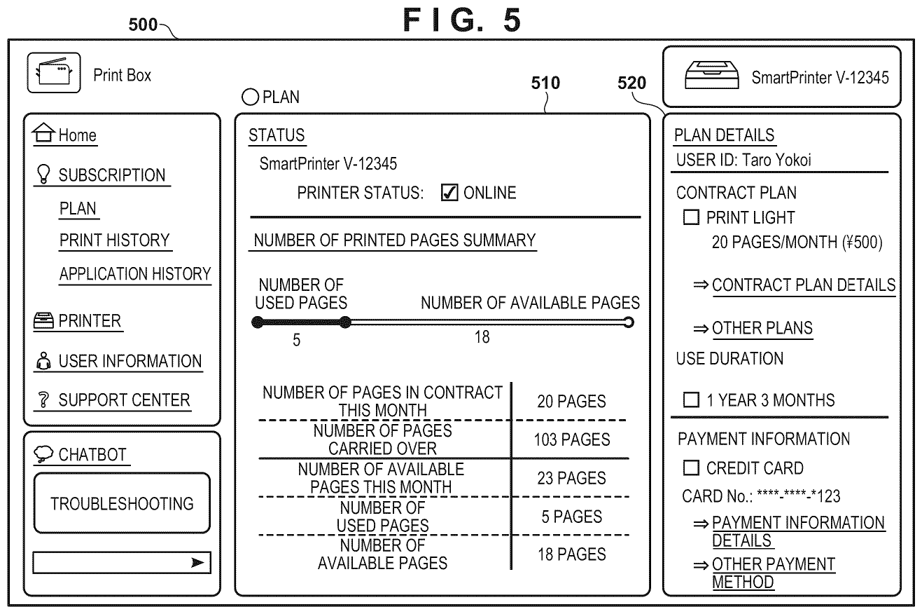

FIG. 5 shows a screen 500 as an example of a graphical user interface (GUI) provided by the management server 301 and displayed on the display unit of the user terminal 401. The screen 500 is displayed on the display unit of the user terminal 401 when the user (contract user) logs in to the management system 300 using the user terminal 401. Information held in the management DB 313 of the management server 301 is displayed in the screen 500. The information displayed in the screen 500 includes the content of the contract that the user using the image forming apparatus 1 and the user terminal 401 in the user environment E1 has made with the business operator operating the management system 300 to receive the subscription service.

The screen 500 includes regions 510 and 520. Information regarding items included in the print data table 340 in the management DB 313 is displayed in the region 510. Information regarding items included in the account table 320 and the device registration table 330 in the management DB 313 is displayed in the region 520. The screen 500 is configured to enable the user to check the information that is held in the management DB 313 and managed by the management server 301 via the screen. The screen 500 is also configured to enable the user to change the content of the contract (contract plan) regarding the subscription service provided by the business operator via the screen.

### Request Destination User ID Registration Processing

FIG. 6 is a sequence diagram showing an example of registration processing in which one or more user IDs, which can be used as a request destination for a user to request an increase in the number of printable pages specified in a contract, are registered as a request destination user ID in association with the contract. The sequence shown in FIG. 6 involves the management server 301, the user terminal 401, and the user terminal 402. The user who operates the user terminal 401 will be referred to as “user A,” and the user who operates the user terminal 402 will be referred to as “user B”. Note that it is assumed here that the account information of the users (users A and B) has already been registered in the account table 320 included in the management DB 313 of the management server 301 before the start of the sequence shown in FIG. 6.

In this example, a case will be described in which the user A operating the user terminal 401 requests that the user ID of the user B operating the user terminal 402 be registered as a request destination user ID. First, in step S600, the user terminal 401 displays a login screen and accepts input of a user ID and a password from the user A via the login screen. In step S601, the user terminal 401 transmits a login request including the input user ID and password to the management server 301.

In step S602, the management server 301 (authentication unit 380) executes user authentication based on the user ID and the password received from the user terminal 401. Here, it is assumed that the user authentication is successful and login to the management system 300 is successful. In step S603, the management server 301 transmits an authentication success notification, indicating that the user authentication has been successful, to the user terminal 401 as a response to the login request. Subsequent processing in the sequence shown in FIG. 6 is performed while the login session of the user A (user terminal 401) continues.

In step S604, the user terminal 401 accepts input of the request destination user ID from the user A via a request destination user ID input screen. In this example, the user ID of the user B who is operating the user terminal 402 is input as the request destination user ID. After completion of the input of the user ID, in step S605, the user terminal 401 transmits an ID registration request including the input user ID to the management server 301.

Upon receiving the ID registration request from the user terminal 401, the management server 301 (registration processing unit 370) transmits a notification regarding the ID registration request to the user corresponding to the user ID included in the registration request. In response to the user approving the registration request, the management server 301 performs registration according to the registration request. Specifically, in step S606, the management server 301 transmits a notification regarding the ID registration request to the email address registered in the account table 320 in association with the user ID included in the received ID registration request (the user ID of the user B). Accordingly, the user terminal 402 used by user B can receive the notification regarding the ID registration request by email.

Upon receiving the notification regarding the ID registration request from the management server 301, in step S607, the user terminal 402 displays a login screen and accepts input of a user ID and a password from the user B via the login screen. In step S608, the user terminal 402 transmits a login request including the input user ID and password to the management server 301.

In step S609, the management server 301 (authentication unit 380) executes user authentication based on the user ID and password received from the user terminal 402. Here, it is assumed that the user authentication is successful and login to the management system 300 is successful. In step S610, the management server 301 transmits an authentication success notification, indicating that the user authentication has been successful, to the user terminal 402 as a response to the login request. Subsequent processing in the sequence shown in FIG. 6 is performed while the login session of the user B (user terminal 402) continues.

After transmission of a notification regarding the ID registration request, when the user B logs in to the management server 301, the management server 301 (registration processing unit 370) causes an input screen to be displayed by the user terminal 402 used by the user B to accept input regarding whether or not to approve the registration request (i.e., whether or not to approve registration of the user ID of the user B as the request destination user ID). The user terminal 402 displays the above-described input screen provided by the management server 301 in step S611.

The user terminal 402 receives an instruction from the user B via the displayed input screen. Here, it is assumed that the input instruction is an instruction indicating that registration of the user ID of the user B as the request destination user ID is approved. In response to the approval by the user B, in step S612, the user terminal 402 transmits, to the management server 301, an approval instruction indicating that the registration of the user ID of the user B was approved.

Upon receiving the approval instruction from the user terminal 402, in step S613, the management server 301 (registration processing unit 370) performs registration processing for registering one or more user IDs that can be used as a request destination user ID for the user A in accordance with the approval instruction. In this registration processing, the user ID of the user B is registered as the one or more user IDs that can be used as a request destination user ID for the user A to request an increase in the number of printable pages specified in the contract. The user ID of the user B is registered in the account information of the user A included in the account table 320 as a request destination user ID. Thereafter, in step S614, the management server 301 transmits to the user terminal 401 an approval notification indicating the result of the registration processing.

With the above registration processing, when the user A makes a change request to increase the number of printable pages in a contract with a business operator, the user A can select (specify) the request destination user ID to be used from among one or more user IDs registered in association with the contract.

### GUIs Related to Registration Processing

FIGS. 7A to 7E show examples of screens (GUI) related to registration processing for registering a request destination user ID, which are provided by the management server 301 and displayed on the display units of the user terminals 401 and 402.

A screen 700 shown in FIG. 7A shows user information of the user A who uses the user terminal 401. The user ID of the user A and a serial number (serial No.) are displayed as the user information. In this example, the user ID of the user A is “Yokoi Taro”. Here, “not registered” is displayed for the request destination user ID in the screen 700. This indicates that a request destination user ID is not registered for the account information of the user ID “Yokoi Taro” included in the account table 320 held by the management server 301. Note that a request destination user ID is not registered in the initial account information. When a button 701 for instructing registration (addition) of a request destination user ID is pressed on the screen 700, the display screen of the user terminal 401 switches to a screen 710 shown in FIG. 7B.

The screen 710 is used to input a serial number corresponding to the request destination user ID. The serial number can be input by inputting characters into an input field 711. Also, by pressing a button 712, it is also possible to select input of a serial number by reading a two-dimensional code (QR code (registered trademark) in this example) using the camera function of the user terminal 401. When an OK button 713 is pressed after completion of the input of the serial number, the input serial number is transmitted from the user terminal 401 to the management server 301. The management server 301 acquires the user ID corresponding to the received serial number from the account table 320 of the management DB 313, and transmits the acquired user ID to the user terminal 401. Upon receiving the user ID from the management server 301, the user terminal 401 displays a screen 720 shown in FIG. 7C.

The screen 720 shows the user ID received from the management server 301 (in this example, the user ID “Suzuki Jiro” of the user B). The user B checks the displayed user ID and presses the OK button 721 on the screen 720, and then the user terminal 401 transmits, to the management server 301, an ID registration request (step S605) requesting that the user ID be registered as a request destination user ID. Upon receiving the ID registration request, the management server 301 transmits a notification regarding the ID registration request to the user terminal 402 (step S606), as described above.

In response to receiving the notification regarding the ID registration request, the user terminal 402 logs in to the management system 300 as necessary (steps S607 to S610). After the login is complete, the user terminal 402 displays a screen 730 shown in FIG. 7D. The user B can check the content displayed on the screen 730 and press an OK button 731 to instruct approval of the ID registration request (step S611). When the OK button 731 is pressed, the user terminal 402 transmits, to the management server 301, an approval notification indicating that the registration (addition) of the request destination user ID is approved (step S612).

Upon receiving the approval notification from the user terminal 402, the management server 301 causes the user terminal 401 to display a screen 740 shown in FIG. 7E. In this example, the screen 740 displays the user ID “Suzuki Jiro” of the user B as the request destination user ID.

### Change Processing for Changing Number of Printable Pages

FIG. 8 is a sequence diagram showing an example of change processing for changing the contracted number of printable pages for a user in response to a request from the user. Similarly to the sequence shown in FIG. 6, the sequence shown in FIG. 8 involves the management server 301, the user terminal 401, and the user terminal 402. The user operating the user terminal 401 will be referred to as “user A,” and the user operating the user terminal 402 will be referred to as “user B”. Note that it is assumed here that the account information of the users (users A and B) has already been registered in the account table 320 included in the management DB 313 of the management server 301 before the start of the sequence shown in FIG. 8.

In this example, a case will be described in which the user A operating the user terminal 401 uses a registered request destination user ID to make a request, to the user B corresponding to the request destination user ID, for an increase in the number of printable pages in the contract corresponding to the user A. This request is for increasing the number of printable pages in the contract corresponding to the user A by transfer from the number of printable pages in the contract corresponding to the user B. Note that although the “number of printable sheets” is illustrated in FIG. 8 and FIGS. 9A to 9F, this means the same as “number of printable pages”.

First, in step S800, the user terminal 401 displays a login screen and accepts input of a user ID and a password from the user A via the login screen. In step S801, the user terminal 401 transmits a login request including the input user ID and password to the management server 301.

In step S802, the management server 301 (authentication unit 380) executes user authentication based on the user ID and password received from the user terminal 401. Here, it is assumed that the user authentication is successful and login to the management system 300 is successful. In step S803, the management server 301 transmits an authentication success notification, indicating that the user authentication has been successful, to the user terminal 401 as a response to the login request. Subsequent processing in the sequence shown in FIG. 8 is performed while the login session of the user A (user terminal 401) continues.

Thereafter, the management server 301 (change processing unit 360) causes an input screen to be displayed by the user terminal 401 of the user A (contract user corresponding to a first contract) who has logged in to the management server 301. The management server 301 further receives, via the input screen, a change request for increasing the number of printable pages (sheets) in the contract with the business operator.

First, in step S804, the user terminal 401 accepts, from the user A via the input screen, input of a request destination user ID, which is for requesting an increase in the number of printable sheets in the contract corresponding to the user A, and a requested number of sheets. Here, the management server 301 (change processing unit 360) may display, as an input screen, an input screen in which one or more user IDs registered by the above-mentioned registration processing (FIG. 6) can be selected as the request destination user ID. In this example, the user ID of the user B who is operating the user terminal 402 is input as the request destination user ID. After completion of the input of the request destination user ID and the requested number of sheets, in step S805, the user terminal 401 transmits, to the management server 301, a change request including the request destination user ID and the requested number of sheets, to increase the number of printable sheets in the contract corresponding to the user A.

Upon receiving the change request to change the number of printable sheets from the user terminal 401, in step S806, the management server 301 (change processing unit 360) transmits a notification regarding the change request. Specifically, the management server 301 transmits the notification to the user B, who is the contract user of a contract (a second contract different from the first contract) associated with the request destination user ID included in the change request, among the contracts managed by the data management unit 350. In this example, the management server 301 transmits the notification regarding the change request to the email address registered in the account table 320 in association with the request destination user ID (the user ID of the user B) included in the change request. Accordingly, the user terminal 402 used by the user B can receive the notification regarding the change request by email.

Upon receiving the notification regarding the change request from the management server 301, in step S807, the user terminal 402 displays a login screen and accepts input of a user ID and a password from the user B via the login screen. In step S808, the user terminal 402 transmits a login request including the input user ID and password to the management server 301.

In step S809, the management server 301 (authentication unit 380) executes user authentication based on the user ID and password received from the user terminal 402. Here, it is assumed that the user authentication is successful and login to the management system 300 is successful. In step S810, the management server 301 transmits an authentication success notification, indicating that the user authentication has been successful, to the user terminal 402 as a response to the login request. Subsequent processing in the sequence shown in FIG. 8 is performed while the login session of the user B (user terminal 402) continues.

Thereafter, in response to the change request being approved by the user B, the management server 301 (change processing unit 360) performs change processing in accordance with the change request. The management server (change processing unit 360) performs change processing to decrease the number of printable pages (number of sheets) in the contract corresponding to the user B (second contract) by the number of pages (requested number of sheets) requested in the accepted change request, and to increase the number of printable pages (number of sheets) in the contract corresponding to the user A (first contract) by the number of pages (requested number of sheets) requested in the change request.

First, after transmission of a notification regarding the change request, when the user B logs in to the management server 301, the management server 301 (change processing unit 360) causes the user terminal 402 of the user B to display an input screen for accepting input regarding whether or not to approve the change request. The user terminal 402 displays the above-mentioned input screen provided by the management server 301 in step S811.

The user terminal 402 receives an instruction from the user B via the displayed input screen (e.g., a screen 930 in FIG. 9D). Here, it is assumed that an instruction indicating approval of the change processing is input. In response to the approval by the user B, the user terminal 402 transmits an approval instruction indicating the above approval to the management server 301 in step S812.

Upon receiving the approval instruction from the user terminal 402, in step S813, the management server 301 (change processing unit 360) performs change processing to change the contracted number of printable pages (number of sheets) of each of the users A and B in accordance with the approval instruction. In this change processing, the requested number of pages (requested number of sheets) is transferred from the number of printable sheets in the contract corresponding to the user B to the contract corresponding to the user A (the number of printable sheets in the contract corresponding to the user B is reduced by the requested number of sheets, and the number of printable sheets in the contract corresponding to the user A is increased by the requested number of sheets).

Thereafter, in step S814, the management server 301 (change processing unit 360) transmits, to the user terminal 401, a notification regarding the change in the number of printable sheets, which indicates the result of the change processing. Similarly, in step S815, the management server 301 transmits, to the user terminal 402, a notification regarding the change in the number of printable sheets, which indicates the result of the change processing.

### GUIs Related to Change Processing

FIGS. 9A to 9F show examples of screens (GUI) related to the above-mentioned change processing for changing the number of printable pages, which are provided by the management server 301 and displayed on the display units of the user terminals 401 and 402. In this example, a case will be described in which the user A operating the user terminal 401 requests the user B to increase the number of printable pages (sheets) in the contract corresponding to the user A by transfer from the number of printable pages (sheets) in the contract corresponding to the user B. Note that similarly to the examples in FIGS. 7A to 7E, the user ID of the user A is “Yokoi Taro” and the user ID of the user B is “Suzuki Jiro”.

A screen 900 shown in FIG. 9A is used by the user A operating the user terminal 401 to set a request destination user ID for requesting an increase in the number of printable pages (number of sheets) in the contract with the business operator (S804). In this example, the user ID of the user B, “Suzuki Jiro”, which was previously set by the processing described with reference to FIG. 6 and FIGS. 7A to 7E, is selected as the request destination user ID using an input field 901 on the screen 900. When an OK button 902 is pressed after the request destination user ID is set, the display screen of the user terminal 401 switches to a screen 910 shown in FIG. 9B.

The screen 910 is used to set a requested number of sheets (the number of sheets that user A wishes to increase) in a change request for changing the number of sheets that can be printed (S804). In this example, the requested number of sheets is set to 100 using an input field 911 on the screen 910. When an OK button 912 is pressed after setting the requested number of sheets, the display screen of the user terminal 401 switches to a screen 920 shown in FIG. 9C.

The screen 920 is a confirmation screen for the user to confirm the request destination user ID and the requested number of sheets in the change request for changing the number of printable sheets. When the OK button 921 on the screen 920 is pressed, the user terminal 401 transmits a change request for changing the number of printable sheets, which includes the request destination user ID and the requested number of sheets that have been set, to the management server 301 (S805). Upon receiving the change request for changing the number of printable sheets, the management server 301 transmits a notification regarding the change request to the user terminal 402 (S806), as described above.

In response to receiving the notification regarding the change request, the user terminal 402 logs in to the management system 300 as necessary (S807 to S910). After the login is complete, the user terminal 402 displays a screen 930 shown in FIG. 9D. A region 931 in the screen 930 displays information included in the received notification regarding the change request. The user B can indicate approval of the change request for changing the number of printable sheets by pressing an OK button 932 on the screen 930 (S811). When the OK button 932 is pressed, the user terminal 402 transmits an approval notification to the management server 301 (step S612). This approval notification indicates approval for increasing the number of printable pages (number of sheets) in the contract corresponding to the requesting user A (first contract) by transfer of the requested number of sheets in the change request from the number of printable pages (number of sheets) in the contract corresponding to the user B (second contract).

Upon receiving the approval notification from the user terminal 402, the management server 301 performs change processing for changing the number of printable pages (number of sheets) in the contracts corresponding to the users A and B, as described above. Specifically, the management server 301 performs processing for transferring the requested number of printable sheets (100 sheets in this example) from the contract corresponding to the user B to the contract corresponding to the user B (i.e., decreasing the number of printable sheets in the contract corresponding to the user B by the requested number of sheets, and increasing the number of printable sheets in the contract corresponding to the user A by the requested number of sheets) (S813). Thereafter, the management server 301 notifies the user terminals 401 and 402 of the result of the change processing (S814, S815).

In accordance with the notification from the management server 301, the user terminal 401 displays a screen 940 shown in FIG. 9E, and the user terminal 402 displays a screen 950 shown in FIG. 9F. The screen 940 shows that the number of printable sheets in the contract corresponding to the user A has been changed (increased) from 0 to 100 sheets by transfer of 100 sheets from the contract corresponding to the user B. On the other hand, the screen 940 shows that the number of printable sheets in the contract corresponding to the user B has been changed (decreased) from 1000 to 900.

As described above, the management server 301 of the present embodiment manages contracts that are related to the use of the image forming apparatus 1 and that specify the number of pages that can be printed by the image forming apparatus 1 within a predetermined period. The management server 301 (change processing unit 360) receives a change request for increasing the number of printable pages in a first contract being managed. The management server 301 (change processing unit 360) changes the number of printable pages in the first contract by change processing for decreasing the number of printable pages in a second contract, which is different from the first contract, by the number of pages requested in the accepted change request, and increasing the number of printable pages in the first contract by the number of pages requested in the change request.

In this way, the management server 301 performs change processing for changing the number of printable pages specified in managed contracts by transferring a requested number of printable pages for a predetermined period between the contracts. Accordingly, for example, even when it becomes necessary to print more pages than the upper limit in a contract, or when there is a surplus in the number of printable pages relative to the upper limit specified in the contract, it is possible to more flexibly change the number of printable pages specified in the contract. Furthermore, this change processing can be realized without the need for the contract user to pay an additional fee on top of the fee for receiving the subscription service.

### Second Embodiment

In the first embodiment, an example is described in which the number of printable pages specified in a contract is changed by transfer of the contracted number of printable pages between the contracts (between a first contract and a second contract) managed by the management server 301. In the second embodiment, an example will be described in which the use of a plurality of image forming apparatuses is specified in one contract. In the following, descriptions of configurations the same as those in the first embodiment will be omitted.

### GUI Configuration Examples

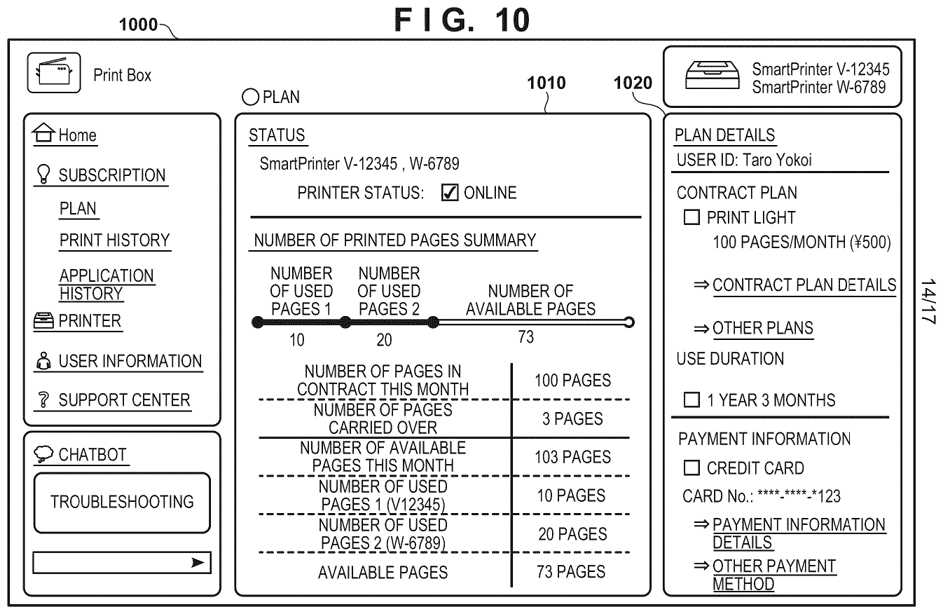

FIG. 10 shows a screen 1000 as an example of a GUI provided by the management server 301 and displayed on the display unit of the user terminal 401. The screen 1000 is displayed on the display unit of the user terminal 401 when the user logs in to the management system 300 using the user terminal 401. The screen 1000 displays information held in the management DB 313 of the management server 301. The information displayed on the screen 1000 includes the content of the contract that the user using the image forming apparatus 1 and the user terminal 401 in the user environment E1 has made with the business operator operating the management system 300 to receive the subscription service.

The screen 1000 includes regions 1010 and 1020. Similarly to the screen 500 (FIG. 5), information regarding items included in the print data table 340 in the management DB 313 is displayed in the region 1010. Information regarding items included in the account table 320 and the device registration table 330 in the management DB 313 is displayed in the region 1020. The screen 1000 is configured to enable the user to check the information that is held in the management DB 313 and managed by the management server 301 via the screen. The screen 1000 is also configured to enable the user to change the content of the contract (contract plan) regarding the subscription service provided by the business operator via the screen.

As shown in the region 1010 of screen 1000, the user ID of the contract user of a contract with the business operator is “Yokoi Taro”, and two image forming apparatuses (printers) respectively having device IDs “V-12345” and “W-6789” are in use. As shown in region 1020, the number of printable pages that can be printed each month (each predetermined period) is 100 pages as specified in the contract with the business operator.

As shown in the region 1010, the number of available pages for the current month (including the carry-over pages) is 103 pages, 10 pages have been printed on the printer “V-12345”, and 20 pages have been printed on the printer “W-6789”. In this example, the remaining number of available pages for the current month is 73 pages, which is obtained by subtracting the number of printed pages printed by the printers “V-12345” and “W-6789” from the number of available pages for the current month. In this way, when a single contract covers multiple image forming apparatuses (printers), the number of printable pages specified in the contract is the total number of printable pages that can be printed by the image forming apparatuses.

As described above, according to the present embodiment, it is further possible for the number of printable pages specified in one contract to be shared among a plurality of image forming apparatuses. Note that in the present embodiment, one contract covers multiple image forming apparatuses, but a configuration may be used in which the total number of printable pages specified in multiple contracts is shared among multiple image forming apparatuses. In such a configuration, as in the first embodiment, processing may be performed in which the number of printable pages specified in a contract is changed by transfer of the number of printable pages between contracts.

### Third Embodiment

In the third embodiment, an example is described in which, when a first contract is terminated, transfer processing is performed in which the number of printable pages in the first contract that remain at the time of termination of the first contract is transferred to one or more other contracts in accordance with an instruction from the contract user of the first contract. In the following, descriptions of configurations the same as those in the first embodiment will be omitted.

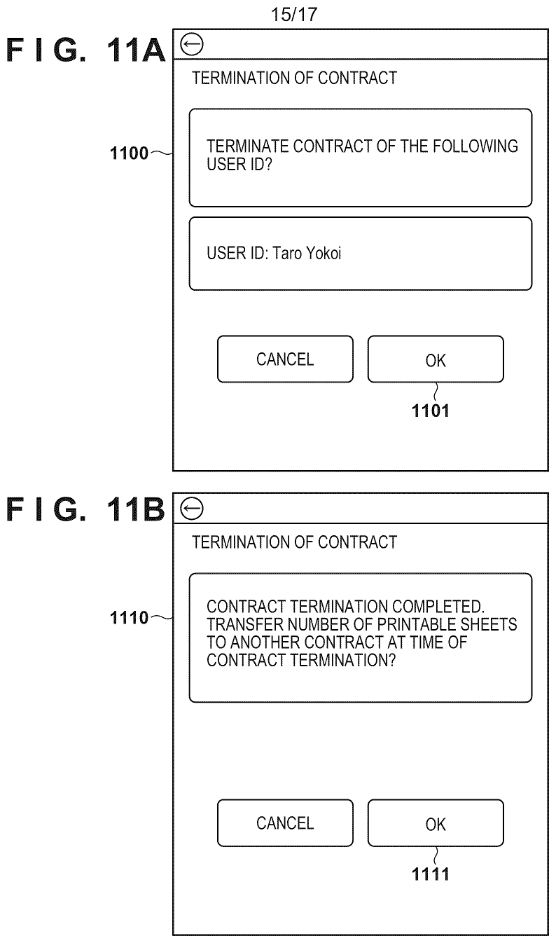

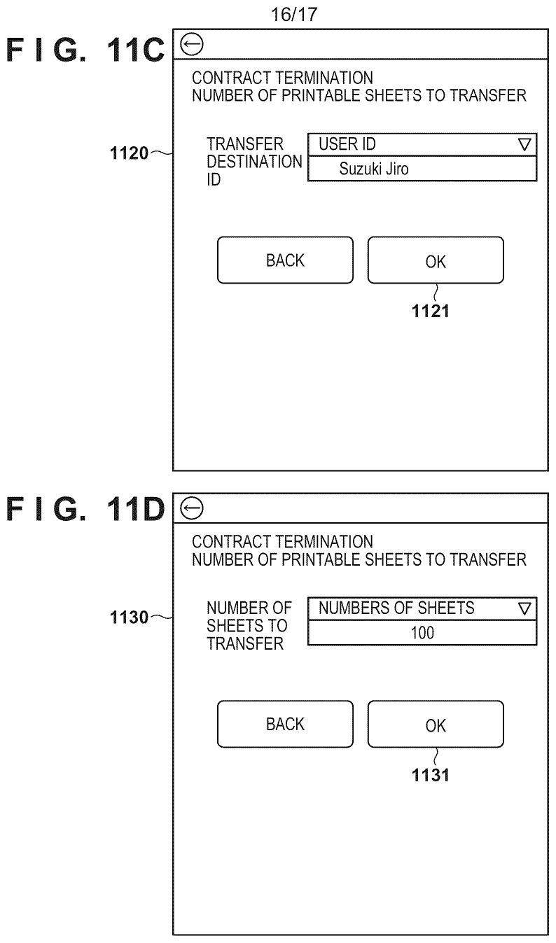

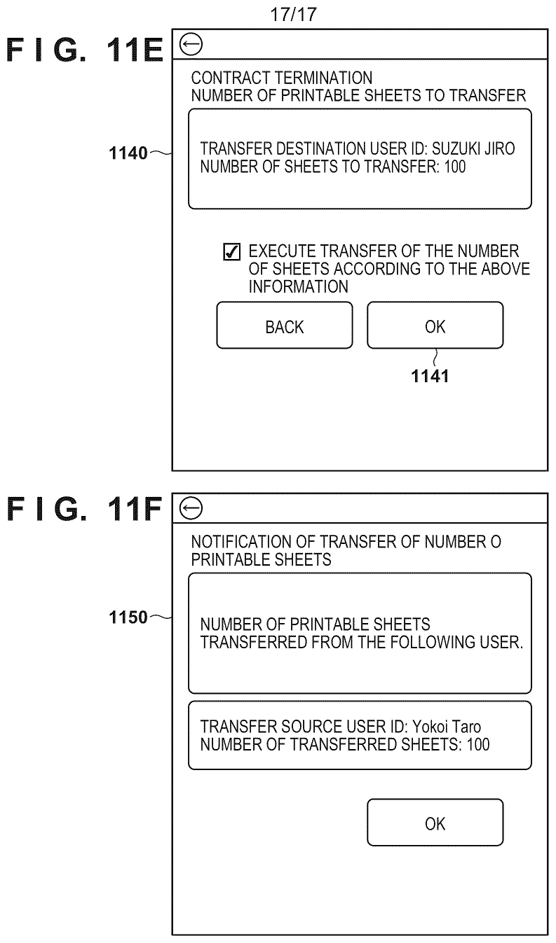

FIGS. 11A to 11F show examples of screens (GUIs) related to transfer processing of the present embodiment, which are provided by the management server 301 and displayed on the display units of the user terminals 401 and 402.

A screen 1100 shown in FIG. 11A is a screen for the user A (user ID “Yokoi Taro”) operating the user terminal 401 to input an instruction to terminate a contract with a business operator. When an OK button 1101 is pressed on the screen 1100, an instruction to terminate the contract of the user A is transmitted from the user terminal 401 to the management server 301. When the user terminal 401 receives a notification from the management server 301 indicating that the contract termination has been completed, the user terminal 401 switches the display screen to a screen 1110 shown in FIG. 11B.

The screen 1100 is used to notify user A that the contract termination has been completed, and to accept input as to whether or not to perform transfer processing for transferring the remaining number of pages at the time of contract termination, out of the number of printable pages specified in the contract corresponding to the user A, to one or more other contracts. When an OK button 1101 is pressed on the screen 1100, the user terminal 401 switches the display screen to a screen 1120 shown in FIG. 11C.

The management server 301 (change processing unit 360) receives input of a transfer destination user ID and a number of transfer pages indicating the number of pages to be transferred, via an input screen displayed on the user terminal 401. Specifically, the management server 301 accepts input of the transfer destination user ID via the screen 1120. In this example, the user ID of the user B, “Suzuki Jiro”, is selected as the transfer destination user ID. When an OK button 1121 is pressed on the screen 1120, the user terminal 401 switches the display screen to a screen 1130 shown in FIG. 11D. The management server 301 accepts input of the number of transfer pages (number of sheets to be transferred) via the screen 1130. In this example, 100 is input (selected) as the number of sheets to be transferred. When an OK button 1131 is pressed on the screen 1130, the user terminal 401 switches the display screen to a screen 1140 shown in FIG. 11E. Note that the management server 301 (change processing unit 360) may configure an input screen to be displayed on the user terminal 401 used by the user A so as to be able to accept input of one or more transfer destination user IDs and the number of transfer pages to be transferred to each transfer destination ID.

The screen 1140 is configured such that the user can check the transfer destination user ID and the number of sheets to be transferred in the transfer processing. When an OK button 1141 is pressed on the screen 1140, the user terminal 401 transmits, to the management server 301, an instruction to execute the transfer processing, which includes the transfer destination user ID and the number of sheets to be transferred. The management server 301 executes transfer processing in accordance with the execution instruction received from the user terminal 401. Thereafter, the management server 301 transmits a notification indicating completion of the transfer processing to the email address associated with the transfer destination user ID (the email address of the user B). As a result, a screen 1150 shown in FIG. 11F is displayed on the user terminal 402 used by the user B.

As described above, according to the present embodiment, when a first contract is terminated, the number of printable pages that remain (are left over) in the first contract out of the number of printable pages specified in the first contract, can be transferred to another contract. This makes it possible to more flexibly change the number of printable pages specified in a contract.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

The present invention is not limited to the above embodiments and various changes and modifications can be made within the spirit and scope of the present invention. Therefore, to apprise the public of the scope of the present invention, the following claims are made.

What is claimed is:

1. A server apparatus that manages an image forming apparatus, the server apparatus comprising:
a management unit configured to manage a contract related to use of the image forming apparatus, the contract specifying a number of printable pages in a predetermined period for the image forming apparatus;
an acceptance unit configured to accept a change request for increasing the number of printable pages in a first contract managed by the management unit; and
a processing unit configured to change the number of printable pages in the first contract by performing change processing for decreasing the number of printable pages in a second contract, which is managed by the management unit and different from the first contract, by a requested number of pages indicated in the change request accepted by the acceptance unit, and increasing the number of printable pages in the first contract by the requested number of pages indicated in the change request,
wherein the number of printable pages in the predetermined period for the image forming apparatus is a sum of the number of printable pages specified in each contract managed by the management unit and a carry-over number of pages carried over from a previous predetermined period due to a surplus in the number of printable pages specified in the contract in the previous predetermined period.

2. The server apparatus according to claim 1,
wherein in a case where the acceptance unit accepts the change request, the processing unit transmits a notification regarding the change request to a contract user of the second contract, and performs the change processing in accordance with approval of the change request by the contract user.

3. The server apparatus according to claim 2,
wherein in a case where the acceptance unit accepts the change request, the processing unit transmits the notification to an email address associated with the second contract.

4. The server apparatus according to claim 2,
wherein after transmission of the notification, in a case where the contract user of the second contract logs in to the server apparatus, the processing unit causes a terminal device used by the contract user to display an input screen for accepting input of whether or not to approve the change request.

5. The server apparatus according to claim 1,
wherein the acceptance unit causes a terminal device used by a contract user of the first contract who is logged in to the server apparatus to display an input screen, and accepts the change request via the input screen.

6. The server apparatus according to claim 1,
wherein the change request includes the requested number of pages and a request destination user ID to which a request is made to increase the number of printable pages in the first contract,
the second contract is a contract that is managed by the management unit and associated with the request destination user ID, and
in the change processing, the processing unit decreases the number of printable pages in the second contract by the requested number of pages, and increases the number of printable pages in the first contract by the requested number of pages.

7. The server apparatus according to claim 6, further comprising:
a registration unit configured to register one or more user IDs usable as the request destination user ID, in association with the first contract,
wherein the acceptance unit causes a terminal device used by a contract user of the first contract who is logged in to the server apparatus to display an input screen that is for accepting the change request and that enables one or more user IDs registered by the registration unit to be selected as the request destination user ID.

8. The server apparatus according to claim 7,
wherein the registration unit accepts, via the input screen displayed by the terminal device of the contract user of the first contract who is logged in to the server apparatus, a registration request for requesting registration of the one or more user IDs usable as the request destination user ID, and performs registration of the one or more user IDs in accordance with the registration request.

9. The server apparatus according to claim 8,
wherein upon accepting the registration request including the one or more user IDs, the registration unit transmits a notification regarding the registration request to a user corresponding to each user ID included in the registration request, and performs the registration in accordance with approval of the registration request by the corresponding user.

10. The server apparatus according to claim 9,
wherein upon accepting the registration request, the registration unit transmits the notification regarding the registration request to an email address associated with each user ID included in the registration request.

11. The server apparatus according to claim 9,
wherein after transmission of the notification regarding the registration request, in a case where the corresponding user logs in to the server apparatus, the registration unit causes a terminal device used by the corresponding user to display an input screen for accepting input of whether or not to approve the registration request.

12. The server apparatus according to claim 1,
wherein in a case where a contract managed by the management unit covers a plurality of image forming apparatuses, the number of printable pages specified in the contract covering the plurality of image forming apparatuses is a total number of printable pages that can be printed by the plurality of image forming apparatuses.

13. The server apparatus according to claim 1,
wherein the processing unit is further configured to perform transfer processing for, in a case where the first contract is terminated, in accordance with an instruction from a contract user of the first contract, transferring a remaining number of pages at a time of termination of the first contract, out of the number of printable pages specified in the first contract, to one or more other contracts.

14. The server apparatus according to claim 13,
wherein in the transfer processing, the processing unit accepts, via an input screen displayed by a terminal device of the contract user of the first contract, input of a transfer destination user ID and a number of transfer pages, and transfers the number of transfer pages from the number of printable pages specified in the first contract to a contract associated with the transfer destination user ID.

15. The server apparatus according to claim 14,
wherein in the transfer processing, the processing unit accepts, via the input screen displayed by the terminal device of the contract user of the first contract, one or more transfer destination user IDs and a corresponding number of transfer pages for each of the one or more transfer destination user IDs.

16. A control method of controlling a server apparatus that manages an image forming apparatus, the server apparatus including a management unit configured to manage a contract related to use of the image forming apparatus, the contract specifying a number of printable pages in a predetermined period for the image forming apparatus, the control method comprising:
accepting a change request for increasing the number of printable pages in a first contract managed by the management unit; and
changing the number of printable pages in the first contract by performing change processing for decreasing the number of printable pages in a second contract, which is managed by the management unit and different from the first contract, by a requested number of pages indicated in the change request, and increasing the number of printable pages in the first contract by the requested number of pages indicated in the change request,
wherein the number of printable pages in the predetermined period for the image forming apparatus is a sum of the number of printable pages specified in each contract managed by the management unit and a carry-over number of pages carried over from a previous predetermined period due to a surplus in the number of printable pages specified in the contract in the previous predetermined period.

17. A non-transitory computer-readable storage medium storing a program for causing a computer to execute a control method of controlling a server apparatus that manages an image forming apparatus, the server apparatus including a management unit configured to manage a contract related to use of the image forming apparatus, the contract specifying a number of printable pages in a predetermined period for the image forming apparatus, the control method comprising:
accepting a change request for increasing the number of printable pages in a first contract managed by the management unit; and
changing the number of printable pages in the first contract by performing change processing for decreasing the number of printable pages in a second contract, which is managed by the management unit and different from the first contract, by a requested number of pages indicated in the change request, and increasing the number of printable pages in the first contract by the requested number of pages indicated in the change request,
wherein the number of printable pages in the predetermined period for the image forming apparatus is a sum of the number of printable pages specified in each contract managed by the management unit and a carry-over number of pages carried over from a previous predetermined period due to a surplus in the number of printable pages specified in the contract in the previous predetermined period

18. A management system comprising:
an image forming apparatus; and
a server apparatus according to claim 1, the server apparatus being disposed in a remote environment that is distinct from an environment in which the image forming apparatus is disposed.
